(19) United States
(12) Patent Application Publication
(10) Pub. No.: US 2004/0210828 A1
(43) Pub. Date: Oct. 21, 2004

(54) Web interaction system which enables a mobile telephone to interact with web resources

(76) Inventor: Amir Langer, London (GB)

Correspondence Address: Richard C. Woodbridge, Synnestvedt Lechner & Woodbridge, PO Box 592, Princeton, NJ, 08542-0592, US

(21) Appl. No.: 10/486,618

(22) PCT Filed: Aug. 12, 2002
(86) PCT No.: PCT/GB02/03702

(30) Foreign Application Priority Data
Aug. 5, 2001 (GB) 0119488.5

(51) Int. Cl. G06F 15/16

(52) U.S. Cl. 715/501.1; 709/218

(57) ABSTRACT

A web interaction system which enables a mobile telephone to interact automatically with web resources, in which the web interaction system comprises a query engine which operates on XML format data, translated from data obtained from a web site, the query engine parsing the XML into SAX events which are then queried by the query engine. Conventional query engines parse XML into a data object model (DOM) tree and not SAX events; DOM trees can however occupy significant memory space. SAX events on the other hand can be queried as parsing progresses (i.e. no need to wait for an entire DOM tree to be constructed before queries can be first performed). Not needing to wait for an entire web document to download is a major advantage since this would otherwise be a major bottleneck.

### BACKGROUND OF THE INVENTION

1. Field of the Invention

This invention relates to a web interaction system which enables a mobile telephone to interact with web resources. It can, for example, be used by a mobile telephone to locate and purchase goods (e.g. buy CDs, download music or images etc.) or services (e.g. buy train tickets, places bets etc). The web interaction system extracts information from web sites and performs queries on that information to (for example) locate- and/or purchase goods and services of interest. The web interaction system is located in a server remote from the mobile telephone and communicates with it over a wireless WAN, e.g. a GSM network.

2. Description of the Prior Art

Searching web resources using a mobile telephone has conventionally been done by a user manually browsing different WAP (or iMode) sites. This restricts choice to a relatively small subset of possible suppliers—i.e. those with wireless protocol enabled sites. Further, because of the small screen size of mobile telephones, the user interaction process is awkward and can involve many discrete steps, making the process awkward and hence likely not to be completed. Finally, the relatively low data connection speeds of WAP and iMode mobile telephones can make the overall browsing process a slow one. Next generation networks, such as GPRS and 3G, will partly address these problems by offering faster connection speeds and mobile telephones with larger screens. However, the inherent limitations of screen size and data connection speed will still make the overall experience of interacting with web resources (e.g. to undertake mobile commerce) on even a 2.5G or 3G mobile telephone far less appealing than with a desktop machine connected to the Internet over a broadband link. It is therefore possible that users of 2G mobile telephones (and possibly also even 2.5G and 3G phones) will choose not to use their mobile telephones to search web resources

In the Internet, ‘web spiders’ are well known: these are programs which automatically visit large numbers of web sites and download their content for later analysis. Some web spiders go beyond just passively reading content and also can submit simple, pre-defined forms (e.g. giving a password in order to read an access controlled site). Spiders can also be used to automate a real time enquiry from a user to locate goods or services—for example, by visiting a number of travel web sites to obtain the best price for airline travel to a destination etc. defined by a user.

However, web spider functionality is still very limited and is typically only activated once a user has reached a web portal/site. Since most mobile telephones inhibit their users from even connecting to a web portal/site in the first place (because of user interaction and data connection limitations, as explained above), web spiders have had little real impact on mobile commerce undertaken using mobile telephones.

### SUMMARY OF THE PRESENT INVENTION

In a first aspect of the invention, there is a web interaction system which enables a mobile telephone to interact with web resources, in which the web interaction system comprises a query engine which operates on XML format data obtained from content data extracted from a web site, the query engine parsing the XML format data into SAX events which are then queried by the query engine.

Conventional query engines parse XML into a data object model (DOM) tree and not SAX events; DOM trees have certain advantages over SAX events in that, once constructed, it enables complex query processing by navigating through the DOM tree. DOM trees can however occupy significant memory space. SAX events on the other hand can be queried as parsing progresses (i.e. no need to wait for an entire DOM tree to be constructed before queries can be first performed) and are also light on memory (since no large DOM tree needs to be stored). Not needing to wait for an entire web document to download is a major advantage since this would otherwise be a major bottleneck SAX events are method calls—e.g. Java software that calls code to perform an instruction.

In one implementation of the present invention, querying the SAX events can then be done using an event stream based engine of an object oriented XML query language. This again differs from the conventional approach of using a relational (non object oriented) XML query language such as XQuery where the engine cannot operate on a stream of events and must keep the data in memory. The XML output which the query engine operates on is derived from the source web site which is being browsed/interrogated (e.g. for information relevant to goods/services to be purchased). That web site typically provides HTML format data, which is translated into valid XML using a translation engine.

The translation engine can also fully define the nesting semantics (i.e. a parameterised list of rules to handle bad nesting, which is very commonplace on web sites) needed for efficient and valid XML: nesting is sometimes not done in HTML code, but is done in XML, so conventional HTML to XML translators address this problem by multiple closure/re-opening steps, but this leads to very large XML nested structures. Defining the nesting semantics allows for much more compact XML to be generated. The nesting semantics typically cover what tags will open/close a nested structure, what hierarchies of nesting are affected by what tags etc.

Another feature of an implementation of the present invention is that it uses an extensible plug-in framework which allows plug-in components to be readily added to the framework. Typical plug-ins cover different parsers (e.g. SAX event output parsers as described above, as well as conventional DOM parsers), support for different protocols (e.g. HTTP and also HTTPS) and different query languages (e.g. Object oriented XML query languages).

The term ‘mobile telephone’ covers any device which can send data and/or voice over a long range wireless communication system, such as GSM, GPRS or 3G. It covers such devices in any form factor, including conventional telephones, PDAs, laptop computers, smart phones and communicators.

In one implementation, a mobile telephone user sends a request for goods and services using a protocol which is device and bearer agnostic (i.e. is not specific to any one kind of device or bearer) over the wireless network (e.g. GSM, GPRS or 3G) operated by a mobile telephone operator (e.g. Vodafone). The request is directed to the operator, who then routes it through to a server (typically operated by an independent company specializing in designing the software running on such servers, such as Cellectivity Limited), which initiates a search through appropriate suppliers by using the above described web interaction system.

The web interaction system automates the entire web browsing process which a user would normally have to undertake manually. The user in effect delegates tasks to the web interaction system, eliminating the need for continued real time connection to the Internet. The search, may also depend on business logic set by the operator—e.g. it may be limited to suppliers who have entered into commercial arrangements with the mobile telephone operator controlling the web interaction system.

The web interaction system interacts with web resources (not simply WAP, iMode or other wireless protocol specific sites), querying them, submitting forms to them (e.g. password entry forms) and returning HTML results to the translation engine. The translation engine converts the HTML into properly nested XML by generating SAX events; the query engine then applies appropriate queries to the SAX events in order to extract the required information and generally interact with the web site in a way that simulates how a user would manually browse through and interrogate the site in order to assess whether it offers goods/services of interest and to actually order those goods/services.

The objective is for the consumer experience to be a highly simplified one, using predefined user preferences in order to make sure that the goods/services offered to the consumer are highly likely to appeal. When the consumer is presented with goods/services, which are acceptable, he can initiate the purchase from the operator (and not the supplier) using the mobile telephone by sending a request to the operator over the wireless network operated by the operator.

A method of enabling a mobile telephone to interact with web resources, in which the method comprises the steps of:

(a) extracting content data from a web site according to an instruction sent from the mobile telephone;

(b) obtaining XML format data from the content data;

(c) parsing the XML format data into SAX events;

(d) querying the SAX events using a query engine to generate query results;

(e) providing a response to the instruction sent from the mobile telephone using the query result.

### BRIEF DESCRIPTION OF THE DRAWINGS

The present invention will be described with reference to the accompanying drawings in which

FIG. 1 is a schematic representation of a Simple API for XML (SAN API and

FIG. 2 is a schematic representation of a ‘Web Agent’ Framework API.

### DETAILED DESCRIPTION

The present invention is implemented in Web Agents technology from Cellectivity limited of London, United Kingdom. Web Agents technology is a framework that allows easy, rapid and robust implementation of extremely lightweight software components that automate browsing on the world-wide web. The main idea behind the framework is to look at the web as a huge duster of databases. It uses a transfer protocol support to link itself to and perform actions on such a “database”. It also queries the “database” using a query language, in order to extract information from it. The only thing the agent programmer needs to code is the specific way to link to this “database” and the specific structure for the data inside it.

The fundamental building blocks in the framework are

1. Transfer protocol handling support

2. Parsing of content language support.

3. Querying content support

By providing these three building blocks and linking them to one framework unit, Web Agents enables the ability to fully interact with any website, link to it, parse its content and query its content. The framework is written in Java and is built on top of the Java API for XML Processing (JAXP) and in particular the Simple API for XML (SAX. The use of the SAX standard enables better integration of the framework into other products and a very simple integration of any SAX functionality into the framework.

By using the Web Agents framework, the programmer has the complete solution to any activity she wishes to automate on the web. The generated agents are not limited to information extraction or web crawling, for example. There is no limit to any specific activity, specific transfer protocols or specific set of content languages.

Another advantage of the framework is its modularity. Every block implementation can be easily plugged in and out of the system.

The Web Agents implementation provides the complete framework design and interfaces+implementation of support for several transfer protocols (FILE, HTTP, HTTPS), several content languages (XML, HTML, JAVASCRIPT) and a query engine for a new XML query language called Xcomp.

One major decision taken for Web Agents was to use the XML standard even when the content itself is not XML. XML is the universal format for structured data on the Web. Because Web Agents looks at any document on the web as if it was data, using XML fits naturally into the framework. Translating different languages to XML may not be an easy task. In particular, when it translates HTML it needs defined rules about what to generate when the HTML code is not valid XML. Handling such behaviour in a generic way adds to the parser's robustness. The solution to this problem is covered in section 3 (HTML parser).

The decision to use an event-based parser in the framework (use of SAX API) is linked to the demand to create lightweight agents. Keeping a whole XML tree of a web page in memory for every agent instance means not only too much memory but also too slow processing. Web applications' main bottle neck is the web connection. Using the stream based approach minimizes this by getting query results as the page is retrieved from the remote site and not only after it was fully retrieved and the data structure was constructed. This means that we can only use a query engine that works efficiently with a SAX stream. Currently, no such engine exists for any XML query language and in most cases the language itself requires the whole tree in order to evaluate one of its queries. (Specifically, the query languages that are based on relational algebra require a full table to perform any query processing). That is why in the present invention implement a new query language (Xcomp) has been designed with its engine built on top of the SAX interfaces. Note that the Xcomp engine is not part of the whole framework and a different implementation of a query engine for the same or different language can be easily plugged in to the framework.

Xcomp and in its engine performance is optimal. Using a different language or engine may have its affects on the efficiency (both memory and speed) of the agent.

This Detailed Description covers the framework definition in section 2. Then follows a description of two important non standard components built for the framework. The Non-Strict-HTML Parser is covered in section 3. Section 4 describes the Xcomp query language and its implementation on top of an event based (SAX) parser.

2. Web Agents Framework

2.1 Overview

The framework is composed out of Agent objects which create and run Pagent objects.

A Pagent is a component which controls the interaction of an agent with a specific type of page on the web. It contains all the implementation of the interaction with that page, meaning all the calls to the 3 different block instances (protocol, parser and query).

An Agent is a component which controls the flow between one or more pagents (and thus simulates browsing between a specific sequence of pages).

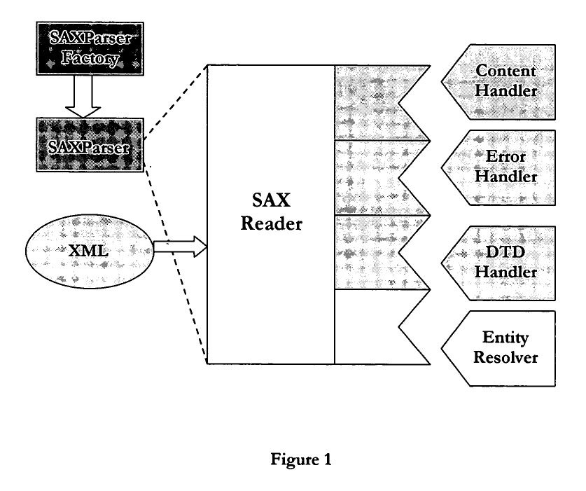

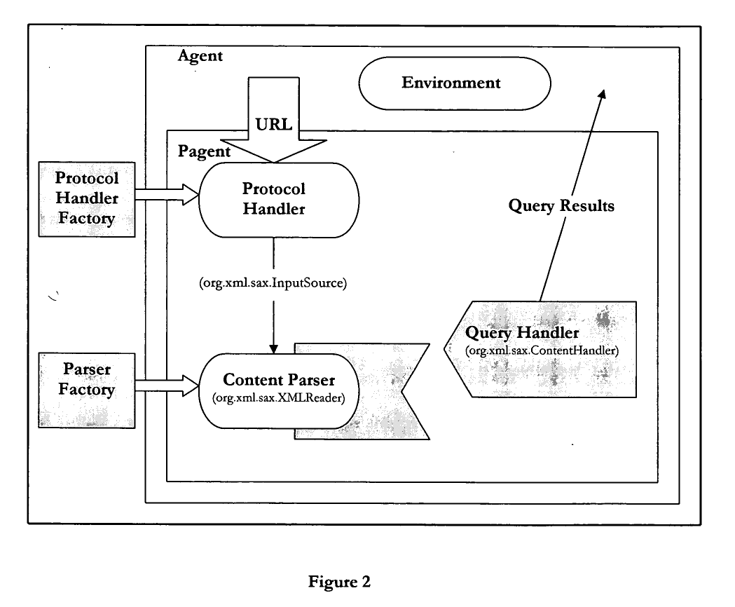

FIGS. 1 and 2 are schematic overviews, with FIG. 1 showing the SAX API standard and FIG. 2 the Web Agents Framework API.

In order to run, a Pagent needs a URL that defines its page and a set of Query Handlers which defines the queries we would like to perform on the page's content. Using the Factory design pattern, the Pagent gets hold of the specific protocol handler and the content parser it needs for its page. This process is done dynamically. The Protocol Handler Factory depends only on the URL to produce a Protocol Handler. The Content Parser Factory can depend on MIME type or file name suffix to produce a Content Handler. A Content Parser is simply the org.xml.sax.XMUReader interface. (SAXReader in FIG. 1). A QueryHandler is simply the org.xml.sax.ContentHandler and it is implemented by any query engine. The framework is built on top of JAXP and therefore, any content parser the framework accepts is a JAXP SAX Parser. The query handler links to this parser as its org.xml.sax.ContentHandler, the object for the callback SAX events.

A ProtocolHandler is an interface that supports the manipulation of its transfer protocol parameters. It also wraps a java.net.URLConnection object and provides its functionality. Finally it links to an Environment object used by the agent thus enabling the agent programmer to persist the browsing state. The environment is a member of every web agent.

Both agent and Pagent can be written directly as a Java class or generated from a script. In section 4.3 we cover our Xcomp implementation including the generation of Pagent code from an Xcomp script.

2.2 Framework Extensions

The Web Agents framework is very generic. On top of the framework, any user can build extensions. Implementations of common generic actions on web sites. A good example of such extension is the form filler.

HTML form filling and submission is a simple HTTP request which is constructed from the data retrieved by a specific query after an HTML parser parsed the form page. Note that this Form filling capability is just a single case covered by the framework.

2.3 Framework API's

2.3.1 ProtocolHandler

```
com.cellectivity.protocol
Class ProtocolHandler
java.lang.Object
  |
  +−com.cellectivity.protocol.ProtocolHandler
```

public abstract class ProtocolHandler

extends java.lang.Object

Super class of all protocol handlers. This class implements generic functionality shared by all handlers. It holds a java.net.URLConnection as a member and uses it to connect to the web and control the connection protocol.

ProtocolHandler (java.net.URLConnection i_conn,
com.cellectivity.agent.pagent.PagentRequest i_request)
all protocol handlers must have such a constructor in order to be
created by the ProtocolHandlerFactory

| | |
|---|---|
| java.lang.String | getContentType( ) |
| | get the content type of this connection |
| abstract | getDefaultParser( ) |
| org.xml.sax. | return the default parser for this protocol. |
| XMLReader | |
| abstract | getDefaultParserName( ) |
| java.lang.String | return the default parser for this protocol. |
| java.util.HashMap | getResponseHeader( ) |
| | get all response headers |
| java.util.HashMap | getResponseHeader (java.util.HashMap resultMap) |
| | fill the hash map all response headers. |
| java.lang.String | getResponseHeaderField (java.lang.String |
| | field) |
| | get the value of the first occurence of the |
| | response header defined by the input param. |
| java.lang.String[] | getResponseHeaderFields (java.lang.String |
| | field) |
| | return all values for this response header field |
| java.net.URL | getURL( ) |
| | URL of this connection |
| org.xml.sax. | resolveInputSource( ) |
| InputSource | connect to the remote site and return the input |
| | stream. |

2.3.2 ProtocolHandlerFactory

```
com.cellectivity.protocol
Class ProtocolHandlerFactory
java.lang.object
  |
  +−com.cellectivity.protocol.ProtocolHandlerFactory
```

public class ProtocolHandlerFactory

extends java.lang.Object

create a protocol handler according to the default class name “com.cellectivity.protocol.Handler.class” and if no class is found or an error occured try look for a name in the global config (key protocol//handler”

ProtocolHandlerFactory( )

| | |
|---|---|
| static | createProtocolHandler |
| com.cellectivity. | (com.cellectivity.agent.pagent. |
| protocol.ProtocolHandler | PagentRequest i_request) |
| | create a Protocol Handler |
| | from the given Pagent Request |

2.3.3 ParserFactory

```
com.cellectivity.content
Class ParserFactory
java.lang.Object
  |
  +−com.cellectivity.content.ParserFactory
```

public class ParserFactory

extends java.lang.Object

Create a parser for a specific content type. The content is defined by either name (allow programmer to override), mine type or filename suffix.

The factory looks in the environment object for the values of the properties of the format:

“content/sax/parser/*”

“content/sax/parser/mime/*”

“content/sax/parser/suffix/*”

where * is the value it has for that particular property type.

It looks for the values in that order and returns the parser whose class name is the value of that name. If none found or some error occured, it returns the default parser defined for each protocol handler.

ParserFactory( )

| | |
|---|---|
| static org.xml. | createParser (java.lang.String contentName, |
| sax.XMLReader | com.cellectivity.protocol.ProtocolHandler |
| | ph, |
| | com.cellectivity.agent.www.Environment |
| | env) |
| | create a parser according to algorithm |
| | described above. |
| static org.xml. | createParser (java.lang.String contentName, |
| sax.XMLReader | com.cellectivity.protocol.ProtocolHandler |
| | ph, |
| | com.cellectivity.agent.www.Environment |
| | env, java.lang.String def) |
| | override the default parser using this |
| | method |

2.3.4 PagentRequest

```
com.cellectivity.agent.pagent
Class PagentRequest
java.lang.Object
  |
  +−com.cellectivity.agent.pagent.PagentRequest
All Implemented Interfaces:
    java.io.Serializable
```

public class PagentRequest

extends java.lang.Object

implements java.io.Serializable

A request object to a Pagent This object wraps together the agent environment, a URL, a timeout value and a generic additional data object

See Also:

Serialized Form

PagentRequest(java.lang.String i_url,
com.cellectivity.agent.www.Environment i_env, long i_timeout)
PagentRequest(java.lang.String i_url,
com.cellectivity.agent.www.Environment i_env, long i_timeout,
java.io.Serializable i_additionalData)

| | |
|---|---|
| java.io.Serializable | getAdditionalData( ) |
| com.cellectivity.agent. | getEnv( ) |
| www.Environment | |
| long | getTimeout( ) |
| java.lang.String | getUrl( ) |
| void | setAdditionalData(java.io.Serializable |
| | i_additionalData) |
| void | setEnv(com.cellectivity.agent.www.Environment |
| | i_env) |
| void | setTimeout (long i_timeout) |
| void | setUrl(java.lang.String i_url) |

2.3.5 Environment

```
com.cellectivity.agent.www
Class Environment
java.lang.Object
  |
  +−com.collectivity.agent.www.Environment
All Implemented Interfaces:
    java.io.Serializable
```

public class Environment

extends java.lang.Object

implements java.io.Serializable

General Environment object for an agent.

See Also:

com.cellectivity.protocol.http.HttpEnvironment. Serialized Form

Environment( )
create a new empty environment.

| | |
|---|---|
| Environment | cloneEnvironment(java.lang.String referer) clone |
| | this environment and set the referer to be ‘referer’ |
| java.lang.Object | getParameter(java.lang.String key) |
| java.util.HashMap | getParameters( ) |
| java.util.SortedMap | getProperties(java.lang.String pathKey) |
| java.util.Iterator | getPropertiesKeys(java.lang.String pathKey) |
| java.util.Iterator | getPropertiesValues(java.lang.String pathKey) |
| java.lang.String | getProperty(java.lang.String key) |
| java.net.URL | getReferrer( ) |
| java.lang.String | removeProperty(java.lang.String key) |
| void | setParameter(java.lang.String key, |
| | java.lang.String value) |
| void | setParameters(java.util.HashMap params) |
| void | setProperty(java.lang.String key, |
| | java.lang.String value) |
| void | setReferrer(java.lang.String referrer) |
| void | setReferrer(java.net.URL referrer) |

2.3.6 Pagent

com.cellectivity.agent.pagent

Interface Pagent

public interface Pagent

A Pagent from the point of view of the programmer. Any implementation of this interface is a specific behaviour for a specific Pagent. This can include some generic behaviour for a type of queries (preferrably done inside an abstract class that will be subclassed by specific queries of that type) or handling of specific query results on a page.

| | |
|---|---|
| void | service(com.cellectivity.agent.pagent. |
| | PagentRequest i_request) |
| | This is the method which the Agent of |
| | this Pagent ask to process a request from. |
| com.cellectivity. | getEnv( ) |
| agent.www.Environment | Gets the env attribute of the Pagent object |
| com.cellectivity.agent. | getPagentRequest( ) |
| pagent.PagentRequest | Gets the PagentRequest attribute of the |
| | Pagent object |
| java.lang.String | getParserName( ) |
| | Gets the parserName attribute of the |
| | Pagent object |
| com.cellectivity.message. | getProcessingContext( ) |
| ProcessingContext | Gets the processingContext attribute of |
| | the Pagent object |
| long | getTimeout( ) |
| | Gets the timeout attribute of the Pagent |
| | object |
| java.lang.String | getUrl( ) |
| | Gets the url attribute of the Pagent object |
| void | init( ) |
| java.lang.Runnable | pluginQuery(com.cellectivity.query.Q |
| | ueryListener i_queryListener, |
| | com.cellectivity.util.logging.Logger i_logger) |
| | prepare the specific query/ies stuff before |
| | we start parsing the content and plug it into the |
| | XMLReader. |
| void | setRequest(com.cellectivity.message. |
| | ProcessingContext i_context, |
| | com.cellectivity.agent.pagent.PagentRe |
| | quest i_request) |
| | set the request to the pagent. |

2:3.7 Agent

com.cellectivity.agent.www

Class Agent

com.cellectivity.agent.www.Agent

public abstract class Agent

An Agent that access pagents and controls browsing on the web.

```
Agent( )
  Construct a Agent with no initial environment.
Agent(com.cellectivity.agent.www.Environment i_env)
  Construct a Agent with an initial environment.
```

| | |
|---|---|
| com.cellectivity. | connectAndForget(com.cellectivity.agent. |
| protocol. | pagent.PagentRequest i_request) |
| ProtocolHandler | send a request for a page to a remote host and |
| | don't bother to parse the reply. |
| com.cellectivity.agent. | getEnv( ) |
| www.Environment | Gets the env attribute of the Agent object |
| com.cellectivity.agent. | getPagentRequest(byte i_method, |
| pagent.PagentRequest | java.lang.String i_url, |
| | java.lang.String[] i_keys, |
| | java.lang.String[] i_values, |
| | long i_timeout) |
| | return a PagentRequest to visit the url and pass |
| | the params |
| com.cellectivity.agent. | getPagentRequest(byte i_method, |
| pagent.PagentRequest | java.lang.String i_url, |
| | java.lang.String[] i_keys, |
| | java.lang.String[] i_values, |
| | long i_timeout, java.net.URL i_referer) |
| | return a PagentRequest to visit the url and pass |
| | the params |
| com.cellectivity.agent. | getPagentRequest(java.lang.String i_url, |
| pagent.PagentRequest | long i_timeout) |
| | return a simple PagentRequest to visit the param |
| | url |
| void | setEnv(com.cellectivity.agent.www.Environment |
| | i_env) |
| | Sets the env attribute of the WebBrowsingAgent |
| | object |
| void | setReferrer(java.net.URL i_referrer) |

3. HTML Parser

HTML documents are the most common type of document on the web and they probably have at least one of the following differences which make them non-valid XML documents.

1. It contains elements that start and do not dose

2. It contains bad nesting

3. There is no root element

4. XML element names must be lower case where EEL is case insensitive.

5. Element attributes are not always quoted and some attributes contain no value at all.

6. .HTML contains tags which their content is defined as plaintext—Not available in XML.

This prevents us from using an XML parser to parse HTML files. The great versatility and differences between the HTML 4.0 specification, browsers extensions and finally, the non-valid HTML code in many sites that browsers accept as valid, also prevents us from writing a strict HTML parser for the language. Web Agents requires a fast and robust syntactic parser which will parse a special form of HTML called Non-Strict-HTML. The implementation has three unique features.

1. The parser is not strict. It does not expect valid HTML. It does not work according to any DTD and does not check the validity of any tag or attribute. It parses whatever is on the page, meaning it only identifies tags, comments, text etc.

2. The parser implements org.xml.sax.XMLReader—It fits into the SAX API.

3. Because it translates HTML to XML it has a parameterized list of rules to handle bad nesting (Very common case in HTML on the web).

Other differences between XML and HTML are resolved according to the table below.

HTML Parser behaviour for specific XML validity problems in HTML.

| | | Non XML valid | |
|---|---|---|---|
| No. | Description | HTML example | Parser conforms to |
| 1 | Document well- | <a><b></a></b> | <a><b></b></a><b></b> |
| | formedness | | |
| 2 | No root Element | missing | Wrapping all document in out own |
| | | <html> </html> | root element. (XHTML: adding |
| | | | <html> </html> (and risking |
| | | | there's another one soon)) |
| 3 | Element and | <AbC> | <abc> |
| | Attribute names in | | |
| | lower-case | | |
| 4 | For Non-empty | <p> paragraph ... <p> | <p> paragraph ... </p><p>...</p> |
| | elements, end tags | ... | (Done for a pre-defined set of |
| | are required | | elements whose end-tags are |
| | | | ignored) |
| 5 | Attribute values | <table border=3> | <table border=“3”> |
| | must be quoted | | |
| 6 | Attribute | <option selected> | <option selected=“selected”> |
| | minimization | | |
| 7 | Empty elements | <br> | <br/> |
| 8 | Whitespace | <input value=“ my value ”> | No change (accept it as is) |
| | handling in | | (XHTML: <input value=“my value”>) |
| | attribute values | | |
| 9 | Script and Style | <script> unescaped | <script><![CDATA[... unescaped |
| | elements | script content | script content ...]]></script> |
| | | ...</script> | |
| 10 | SGML exclusions | <a><a></a></a> see | accept it as is (XHTML: issue |
| | | Appendix B of | warning as in all cases) |
| | | XHTML for a full list | |
| 11 | The elements with | <a name=“myName”> | No change (accept it as is) |
| | ‘id’ and ‘name’ | | (XHTML: <a id=“myName”>) |
| | attributes | | |
| 12 | <!DocType> | <!DOCTYPE HTML | Accept it as a tag with elements |
| | SGML decleration | PUBLIC “- | (XHTML: SGML Decleration) |
| | | //W3C//DTD HTML | |
| | | 4.0 transitional//EN”> | |
| 13 | Comments | <!-- comment --> | Omit them |
| 14 | STYLE, SCRIPT, | <SCRIPT> if (0 < 1) | <script><![CDATA[ ... unescaped |
| | SERVER, | etc ... </SCRIPT> | script content ...]]></script> |
| | COMMENT, | | |
| | PLAINTEXT, | | |
| | XMP, TEXTAREA | | |
| | code | | |

The parser follows the same lines as the org.xml.sax.XMLReader with several minor changes: The extended SAX API of LexicalEventListener and DTDEventListener are ignored (it does not validate the code). A new listener NonStrictParsingListener has been introduced to mark events where the parser had to modify the original content in order to remain valid or had to ignore content in order to remain valid. In order to be as efficient as possible, the amount of NonStrictParsing events this parser fires is limited to cases where no error event is fired.

The parse is highly configurable and its rules of nesting can be modified according to specific erratic behaviour of different sites. The main idea is that whenever we encounter bad nesting elements we can decide what to do according to those elements and this will affect the generated XML. For example, one of the options is to define elements as block tags and then everything inside them will be closed when their scope ends. If an element is not defined as a block, the open elements will need to be closed (We must have valid nested tags), but then they will re-open after the element's scope ended.

See Appendix III for an example of scope rules for the HTML Parser.

4. Xcomp

4.1 Overview

Xcomp is a query language for XML content. It is based on a research OODB query language called Comprehension (or COMP for short) and on Xpath for applying the queries to XML. Xcomp's strength lies in the fact that it is adapted to the object oriented nature of XML and that its definition and functionality allows a very efficient implementation based on a parsed stream of events (SAX) and does not require the parsing of the whole XML document in order to start returning results. This has a huge importance when you deal with the web and waiting for a whole document to download and saving all of it in memory is simply too heavy for your process. The remainder of this document will introduce the language syntax and semantics. Then the compiler and engine are described.

4.2 Syntax & Semantics

The Xcomp language syntax is based on COMP where the variables declarations are done using XPath-like expressions.

See Appendix I for the Xcomp BNF grammar.

4.2.1 Select & Where

Every expression is surrounded by curly braces ‘{ }’ and is split into two parts by a vertical line ‘|’.

To use SQL terminology, the left side of the expression is the select part and the right side is the where part.

Xcomp query basic syntax

{ select | where }

This is the basic syntax for every COMP expression and is borrowed from a definition of a set in set theory.

The select is one or more expressions.

The where part is split into variable declarations and conditions.

4.2.2 Query Results

A result of an Xcomp query is defined as a set (only in the framework this set is translated to a sequence of events).

Each element in this set (or each event) is the list of all the values of the select part according to the variables evaluated in the where part and only if all the conditions values inside the where part were true.

A result is evaluated when the scope of a range expression variable is closed. (See section 4.2.4 for an explanation about range expressions).

4.2.3 Expressions

An Xcomp query is composed from expressions which are evaluated by the engine. These expressions may appear in the select part to define a value we want to select. They can appear as the declaration of a variable or they can appear as a value inside a condition where a relational or conditional operator is applied on.

An expression can be one of the following types:

1. A constant,

2. A Pagent parameter (its value depends on the context in which the query runs).

3. An XPath-like expression

4. A variable object.

5. A member field of a variable object

6. A method call on a variable object

An XPath-like expression is a subset of the XPath definition. In Xcomp, we define the path using separators ‘/’ or ‘//’, tag names and the Kleene star ‘*’.

For ‘a/b’ to match a path, ‘b’ should be nested directly below ‘a’.

For ‘a//b′b’ to match a path, ‘b’ should be nested somewhere inside the scope of ‘a’.

A Kleene star means any element

The path can start with a variable or with a separator. If it starts with a variable then the root of the path will be this variable value. A separator means the path's root is the root of the document. Any path can contain inner conditions inside brackets. ‘[ ]’. Those conditions can also be general (using the variables in scope) but usually they will be specific to that path's element.

A member field of an object applies only for objects of type ELEMENT. Calling “x.foo”, is simply a shorthand for using the method x.getAttrValue (“foo”).

A method is defined on a variable. The method declaration needs to be declared outside the Xcomp expression.

Xcomp allows using any Java method for any object (See section 4.3.1 for more details).

Xcomp expressions examples

| | |
|---|---|
| NULL | Constant |
| TRUE | Constant |
| 5 | Constant |
| param(“NameOfForm”) | Parameter |
| x | Object (x is a variable previously declared) |
| x.href | Object field (x is a variable |
| | previously declared) |
| x.perl5Split(“\\s(.)\\s”) | Object method (x is a |
| | variable previously declared) |
| //a/b/*/*/d | XPath-like expression |
| //a/b[.width > 20]// | XPath-like expression |
| c/d[.size == “100%”] | |
| x//a//b | XPath-like expression (x is a variable |
| | previously declared). |

4.2.4 Variables

There are two types of variable declarations in Xcomp:

1. A simple assignment marked in the Pascal syntax ‘:=’.

2. A range expression (marked ‘::=’). Range expression variables are declared using an XPath-like expression.

An assignment defines a variable by giving the expression that evaluates this variable's value.

A range expression must be defined only by a path and therefore its type will always be an ELEMENT. Any range expression in an Xcomp query defines not only the variable value but also when the engine will try to evaluate a result for the query. This is how the query programmer can define iteration on a set of values on the XML source (like a list of prices on a site, list of search results links etc.) If the query programmer is only after one matched pattern then this rule will still apply and the pattern that needs to be matched by the query must defined so there's only one. This is a good practice in a structured data such as XML which the language forces on the user.

The scope of any variable is the select area and the where area immediately to the right of its declaration. This definition prevents expressions with several variables with the same name and also prevents a deadlock where values of different variables depends on each other's value.

Variable declaration scope

{ x , y | x::=//table , y::=x/tr ... }
Scope of variable ‘x’
Scope of variables ‘x’, and ‘y’

4.2.5 Types

The Xcomp language has five main variable types:

1. STRING.

2. INTEGER.

3. BOOLEAN.

4. ELEMENT—An XML element (com.cellectivity.contentElement)—Name and attributes.

5. OBJECT.

The language contains integer constants (defined as. NUMBER—one or more digits.) boolean constants (TRUE or FALSE) and String constants (defined by double quotes around the string text). It also contains NULL—The null keyword.

In addition to these main types, any java type can be integrated into the language. The language core treats those types as Object but the type checking in compile time take note of the specific type and will fail to compile the Xcomp classes if there is a mismatch. Types are used for two things—Type checking in compile time and Type casting in runtime. Type checking is strict only in compile time where it looks for type conflicts and may fail to compile because of that.

The strict typing applies for the results to the query, which are assigned to a specific type, which appears in the method declaration of the listener to the query engine. (The Pagent). Strict typing is also used to check the method calls inside an Xcomp expression. A method can be called from only a specific type. During runtime, the engine will always try to perform a casting from one type to the other.

Type casting rules:

1. Element-->String: Using e.text( );

2. Object-->String: Using o.toString( );

3. String-->Integer: Using Integer.parseInt(s);

4. String-->Boolean: Using Boolean.valueOf(s);

5. Integer-->Boolean: Using (0==integer);

6. NULL-->Integer: −1;

7. NULL-->Boolean: False;

These rules allow the engine to convert types at runtime and solve mismatches. They can also be applied more than once so converting an object to an Integer is done by converting it into a String and then the String into an Integer.

Non strict typing allows more flexibility and adds functionality to the language.

For example:

Xcomp query where casting is needed

{ x | x::=//table , x.width > 50 AND x.height < 20 }

This expression is perfectly legal even though there seem to be a type conflict by comparing an integer to a string. If the width attribute value cannot be translated to an integer value (lets say, “20%”) the condition will throw an exception. This is why this expression should invoke a warning in compile time to alert the programmer that a type conflict might occur. Note that not all possible conversions are made but only ones that gives the programmer flexibility. For example, an Integer will not be converted into a String. Using an integer in a regular expression operator will result in an Xcomp compilation error.

4.2.6 Conditions

Xcomp conditions are simply a convenient common syntax to method with a Boolean return type. The Xcomp language supports all the common equality operators and because of its pluggable nature the user can easily introduce new Boolean methods—new conditions. A group of conditions that were widely used in our implementation, and were added to the language as operators, is pattern matching using regular expressions. We introduced the operators MATCH, CONTAINS and ˜MATCH, ˜CONTAINS (“˜” means case insensitive) as operators in the language.

The integration of regular expressions into Xcomp is a natural progression that adds a lot of power to the language and fits into the stream based approach where the queries are a sort of a structured data pattern match.

The Xcomp language also supports the use of parenthesis ‘( )’ and Boolean operators AND, NOT and OR.

### 4.2.7 EXAMPLES

Below are some example Xcomp queries. Their description below borrows the elements meaning from the HTML language.

{ x.href | x::=//a }

Return all hyperlinks on a page

{ x.ref( ) | x::=//a }

Return the result of the ref method for all hyperlinks on a page

{ x.href | x::=//a , a.href CONTAINS “
http://foo.*” , a.alt != NULL}

Return all hyperlinks on a page which contain the regular expression “http://foo.*” and their alt attribute exists.

{ y | x:=//table , y::=x/tr/td , x.name == “foo”}

Return all table elements in a table named “foo”.

```
{[ x.ref( ) , x.text( ) , y.text( ) ] |
  x::=//a , y::=x//b[.text( ) MATCH “\\s*
  (£|MATCHES BY).*”] ,
  (x.alt == “Click here for details” AND
  (x.class == “litebgartist” OR x.class ==
“litebgtitle”))
}
```

Return a list of a ref method result on a hyperlink, the text of the hyperlink and the text of a bold tag

4.3 Xcomp Language Implementation

This section covers our implementation of the Xcomp language. This is not part of the language definition but many of the Xcomp advantages are derived from this implementation. Xcomp queries are defined in Xcomp files. Those files are ‘compiled’ into java source files of the specific engine for every query.

Appendix II contains the BNF Grammar for Xcomp files.

4.3.1 Methods Declarations

An Xcomp method could be any java method. There is not interface to implement, no special guidelines to follow. The way we link it to Xcomp is by describing it in the Xcomp configuration (or dynamically in the Environment). The only thing the Xcomp engine needs is a mapping between the location of every method that we want to use and the actual method information—the signature; the objects it operates on and some additional flags for optimizations purposes. In order to write methods for java types such as string, the descriptive mode also allows us to define a static method where the object it operates on is given as the first parameter.

The method types in this configuration can be any Xcomp type (OBJECT, ELEMENT, STRING, INTEGER or BOOLEAN) or any Java type (for example, java.lang.String). This is important for the type checking of the methods. If a method is defined to return STRING it means that following Xcomp dynamic casting rules, the type check will pass even if the value of the method is later used as an INTEGER. If however, the return type was java.lang.String, the type check would fail. The same is also true for the type of object which the methods is defined to be on.

Method declarations examples

```
Class ELEMENT;
  // index of variable appearances in the doc.
Signature index( )
Location
com.cellectivity.query.xcomp.DocumentElement.
getVarValueIndex( )
ReturnType INTEGER
Class STRING;
  // Returns trimmed string with 1 space instead of every
whitespace seq.
Signature htmlText( )
Location com.cellectivity.query.xcomp.html.Util.htmlText(this)
ReturnType STRING
SaveText true;
Signature substring(INTEGER)
Location java.lang.String.substring(int)
ReturnType STRING
SaveText true;
Signature substring(INTEGER,INTEGER)
Location java.lang.String.substring(int,int)
ReturnType STRING
SaveText true;
```

In the above example there are four methods defined:

index( ) which operates on an Xcomp ELEMENT type and returns an INTEGER.

htmlText( ) which operates on STRING. The actual implementation of this method will be static (The method does not appear in the actual class which it ‘operates on’—java.lang.String) and it will contain one argument—The object it operates on, marked as this. Note that htmlText( ) operates on STRING which means it will also operate on an object of type ELEMENT or OBJECT. If we would have defined the class name to be—java.lang.String, then calling htmlText( ) on an ELEMENT would give us a type mismatch during compilation. The ‘saveText’ boolean flag is a compiler directive used to define whether the text inside the scope of the element will be used and therefore needs to be saved. The default value is false.—This flag is for optimizations of the engine; we don't want to save the text for every element.

The two other methods are substring(int) and substring(int, int) defined in the java.lang.String class. This example shows the advantage of using a descriptive mode when defining Xcomp methods. No interface needs to be implemented and any java method can be used once it is declared.

4.3.2 Xcomp Set of Queries

Using the Xcomp configuration, we can define one or more query per page. All those queries are unrelated but are processed at the same time on the same stream of events. This enables the query programmer easier integration with the site. In some pages one may want to look for two unrelated pieces of data (like a list of results AND the link to the next page of results). In some cases, one can also define queries which are valid for all the pages of a site and then just add other queries specific to that page. This is particularly easy when the importing capability is used (see section 4.3.4).

4.3.3 Xcomp Filters

By using, the query object as org.xml.sax.XMLFilter and not only org.xml.sax.ContentHandler, one can chain queries and pass the results of one query as the events input for the second query. In some case this could prove a very powerful capability. Specifically, it enables us to save a state during out query processing.

4.3.4 Import Statements

Xcomp configuration allows us to import Xcomp files from other Xcomp files. Using it one can declare methods used frequently in a separate file and then import it. One can define general queries for the whole site and then import it etc.

4.3.5 Framework Configuration from Xcomp

The Xcomp configuration file is also used to define some framework configurations. This is optional as the framework does not require any configuration but, if the programmer requests a specific variant of a parser or wants to override the content parser searching method, she can do so from within the Xcomp file by declaring the content parser by name.

4.3.6 Compiler

Our Xcomp compiler reads the Xcomp file, parse the queries it contains and generates java classes for each query+the Pagent that controls all those query objects, the parser and the protocol handler. The query classes are the Xcomp engines for a particular query. This compilation phase with its configuration Xcomp) files is the only connection between the language implementation and the framework. See Appendix II for the BNF Grammar of the Xcomp file.

4.3.7 Engine

The Xcomp engine implementation is a group of methods to handle specific events and a data structure to maintain the state between those events. The engine contains an event handling method for every start and element of a tag relevant to the query. There is no ‘main’ method for the query processing and it only acts as a reaction to events. This makes it perfect for using with SAX The query processing is managed by the state kept on the query object. This state specifically defines what the value of every path is. Whenever there is an event that closes a tag which results in a value to a range expression variable, the engine will evaluate all conditions, all variable values and will fire a result if there is a need to.

Appendix III

Example for HTML Parser Scope Rules

| | | No | | |
|---|---|---|---|---|
| | Element | Scope | | Close by Next |
| No | Name | Tag | Closes Scope Of | Appearance |
| 0 | ISINDEX | * | | |
| 1 | BASE | * | | |
| 2 | META | * | | |
| 3 | LINK | * | | |
| 4 | HR | * | | |
| 5 | BR | * | | |
| 6 | INPUT | * | | |
| 7 | IMG | * | | |
| 8 | PARAM | * | | |
| 9 | BASEFONT | * | | |
| 10 | AREA | * | | |
| 11 | NEXTID | * | | |
| 12 | RT | * | | |
| 13 | EMBED | * | | |
| 14 | KEYGEN | * | | |
| 15 | SPACER | * | | |
| 16 | WBR | * | | |
| 17 | FRAME | * | | |
| 18 | BGSOUND | * | | |
| 19 | DT | | | +DD |
| 20 | DD | | | +DT |
| 21 | THEAD | | TR, TH | |
| 22 | FIELDSET | | OPTION, SELECT, | |
| | | | LEGEND, | |
| | | | LABEL, BUTTON | |
| 23 | TR | | TD, TH | * |
| 24 | TD | | | +TH |
| 25 | TH | | | +TD |
| 26 | CAPTION | | | |
| 27 | HTML | | all | * |
| 28 | HEAD | | all | * |
| 29 | BODY | | all | * |
| 30 | TABLE | | TR, TD, TH, | |
| | | | CAPTION, | |
| | | | COLGROUP, COL, | |
| | | | THEAD, | |
| | | | TBODY, TFOOT | |
| 31 | UL | | LI | |
| 32 | OL | | LI | |
| 33 | DL | | DD, DT | |
| 34 | DIR | | LI | |
| 35 | MENU | | LI | |
| 36 | SELECT | | OPTION | |
| 37 | TBODY | | TR, TD | |
| 38 | FORM | | OPTION, SELECT, | |
| | | | FIELDSET, LEGEND, | |
| | | | LABEL, | |
| | | | BUTTON | |
| 39 | LEGEND | | | |
| 40 | COLGROUP | | COL | |
| 41 | COL | | | |
| 42 | TFOOT | | TR, TD | |
| 43 | LI | | | * |
| 44 | OPTION | | | * |
| 45 | LABEL | | | |
| 46 | BUTTON | | | |
| 47 | NOFRAMES | | all | |
| 48 | IFRAME | | all | |
| 49 | ILAYER | | all | |
| 50 | LAYER | | all | |
| 51 | NOLAYER | | all | |
| 52 | NOEMBED | | all | |
| 53 | NOSCRIPT | | all | |
| 54 | INS | | all | |
| 55 | DEL | | all | |
| 56 | P | | | * |
| 57 | A | | | * |

1. A web interaction system which enables a mobile telephone to interact with web resources, in which the web interaction system comprises a query engine which operates on XML format data obtained from content data extracted from a web site, the query engine parsing the XML format data into SAX events which are then queried by the query engine.

2. The system of claim 1 in which querying the SAX events is achieved using an object oriented XML query language with an event stream based engine.

3. The system of claim 1 in which the XML format data which the query engine operates on is obtained, either directly or indirectly via a translation engine, by an automated agent from content data relevant to goods or services to be purchased using the mobile telephone.

4. The system of claim 3 in which the web site provides the content data in XML, HTML or Javascript format.

5. The system of claim 4 in which the web site provides content data in non-XML format data, which is translated into valid XML using a translation engine by the web interaction system.

6. The system of claim 5 in which the translation engine can fully define the nesting semantics needed for efficient and valid XML.

7. The system of claim 1 in which the web interaction system uses an extensible plug-in framework which allows plug-in components to be readily added to the framework.

8. The system of claim 7 in which the plug-ins cover different parsers, support for different protocols or different query languages.

9. The system of claim 1 which uses business logic defined by a mobile telephone operator to prioritise or filter search results according to predefined rules.

10. The system of claim 1 in which the system automatically interrogates web based resources from multiple suppliers to allow a user of the mobile telephone to compare similar goods or services from different suppliers without those suppliers needing to provide wireless protocol specific data.

11. The system of claim 1 which automates user defined processes, enabling the user to delegate tasks to the system without the need for continued real time connection to the Internet.

12. The system of claim 1 which can be modified by user defined preferences or profiles.

13. The system of claim 1 which can supply data records defining the details of the process used by customers to look for goods or services to purchase.

14. A method of enabling a mobile telephone to interact with web resources, in which the method comprises the steps of:
(a) extracting content data from a web site according to an instruction sent from the mobile telephone;
(b) obtaining XML format data from the content data;
(c) parsing the XML format data into SAX events;
(d) querying the SAX events using a query engine to generate query results;
(e) providing a response to the instruction sent from the mobile telephone using the query result.

15. The method of claim 14 in which querying the SAX events is achieved using an object oriented XML query language and an event stream query engine.

16. The method of claim 14 in which the XML format data is obtained, either directly or indirectly via a translation engine, by an automated agent from content data relevant to goods or services to be purchased using the mobile telephone.

17. The method of claim 16 in which the web site provides the content data in XML, HTML or Javascript format.

18. The method of claim 14 in which the web site provides content data in non-XML format data, which is translated into valid XML using a translation engine.

19. The method of claim 18 in which the translation engine can fully define the nesting semantics needed for efficient and valid XML.
